(19) United States
(12) Patent Application Publication
(10) Pub. No.: US 2019/0019077 A1
(43) Pub. Date: Jan. 17, 2019

(54) AUTOMATIC CONFIGURATION OF COGNITIVE ASSISTANT

(71) Applicant: Cisco Technology, Inc., San Jose, CA (US)

(72) Inventors: Keith Griffin, Co. Galway (IE); Michael P. Lepore, Marlborough, MA (US)

(21) Appl. No.: 15/651,325

(22) Filed: Jul. 17, 2017

(51) Int. Cl. G06N 3/00; G06F 9/44; G06F 17/30

(52) U.S. Cl. CPC G06N 3/006; G06F 17/30684; G06F 9/4446

(57) ABSTRACT

The present technology is an automatically configuring virtual assistant. The virtual assistant is assigned to an existing conversation space and, based on analyzing the existing conversation space the virtual assistant has been assigned to, is associated with at least one contextual cue of an existing conversation space. The analysis includes natural language processing of a title, a topic, or a past conversation of the existing conversation space in order to determine the at least one contextual cue.

### TECHNICAL FIELD

The present disclosure pertains to a virtual assistant, and more specifically to a virtual assistant that onboards to a conversation space without configuration.

### BACKGROUND

Computer-based systems that include virtual assistants have been used to provide user services, such as customer help services. The virtual assistant takes the form of a chatbot (or assistant, intelligent agent, intelligent service, etc.), which is added to one or more conversation spaces (e.g., chat rooms). When a user asks the chatbot a question, the system refers the chatbot to the chat room that it thinks is the best match. To do this, the chatbot is configured with topics that a chat room typically handles and then looks for terminology matching that configuration.

Configuration, however, is a major problem faced by the chatbot. Manual configuration of topics related to the chat room is required, since chatbots have no other context for the room that it has been added to. Manual configuration limits the flexibility of the chatbot to be easily added to other rooms, and requires time and resources from a chat room owner or administrator.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only example embodiments of the disclosure and are not therefore to be considered to be limiting of its scope, the principles herein are described and explained with additional specificity and detail through the use of the accompanying drawings in which:

FIG. 1 is a conceptual block diagram illustrating an example system for virtual assistant configuration capabilities, in accordance with various embodiments of the subject technology;

FIG. 2A is a flowchart illustrating an exemplary method for configuring a virtual assistant;

FIG. 2B shows an example embodiment for assigning a virtual assistant to a conversation space;

FIG. 3 is a conceptual block diagram illustrating an example system for providing virtual assistant services, in accordance with various embodiments of the subject technology;

FIG. 4 is a flowchart illustrating an exemplary method for providing virtual assistant services;

FIG. 5A shows example user interfaces showing a user query and a conversation space;

FIG. 5B shows an example user interface showing a participant reply in a conversation space;

FIG. 5C shows an example display of providing a reply to a user query; and

FIG. 6 shows an example system embodiment.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview:

A system, method, and computer readable storage medium is disclosed for automatically configuring a virtual assistant. In one aspect, an assignment of the first virtual assistant to an existing conversation space is received, where the first virtual assistant is a participant in that existing conversation space. The existing conversation space is analyzed to determine at least one contextual cue of the existing conversation space. In some aspects, the analysis includes, but is not limited to, natural language processing of a title, a topic, and/or a past conversation of the existing conversation space. The first virtual assistant is associated with the at least one contextual cue.

In another aspect, each virtual assistant within a number of virtual assistants is assigned to a respective existing conversation space. For each virtual assistant, the respective existing conversation space to which it is assigned is analyzed to determine at least one contextual cue of the respective existing conversation space. The analysis can include, but is not limited to, natural language processing of a title, a topic, or a past conversation of the respective existing conversation space. For all or a portion of the virtual assistants, a contextual cue database stores an association between the virtual assistant and the at least one contextual queue of the respective existing conversation space to which each virtual assistant is assigned, and a chatbot interfaces with a user to receive a query. The chatbot determines that one of the virtual assistants associated with the contextual cue is relevant to the query, and sends the query to that determined virtual assistant. The determined virtual assistant receives the query from the chatbot and posts the query in the respective existing conversation space to which it is assigned. The determined virtual assistant receives a reply and provides the reply to the chatbot to be communicated to the user.

### Example Embodiments

The present technology improves limitations of traditional virtual assistants by providing a way for a virtual assistant to automatically configure itself to a conversation space it has been assigned to. The systems and methods herein describe how to onboard a virtual assistant to a conversation space populated by multiple participants. Onboarding a virtual assistant is the process by which the virtual assistant is joined or added to a conversation space, and then learns the conversation in that particular conversation space. In embodiments, the virtual assistant is enabled to understand the content or topics of that conversation space without manual configuration. The virtual assistant does this by analyzing the content of the conversation space to inform itself of the topics covered. Once the virtual assistant gets “up to speed” on what the conversation space is about, it can determine what sort of queries it can reasonably expect answers for from the participants in the assigned conversation space.

Thus, upfront static configuration is not required for the virtual assistant. While the methods and systems describe onboarding a virtual assistant that is simply added to a conversation space without any context for the conversation space, this mechanism is also useful for onboarding intelligent virtual assistants to conversation spaces in general, and thus ameliorates the traditional virtual assistant limitations around manual configuration. Accordingly, the need for a conversation space owner or administrator to manually configure the virtual assistants with topics related to each conversation space it is a member of is reduced or even removed.

The present technology automatically configures a virtual assistant by receiving an assignment of the virtual assistant to a conversation space. A “virtual assistant,” as the term is used herein, refers to a software agent that can perform tasks or services for an individual, and is used interchangeably with “chatbot”, “bot”, “assistant”, “intelligent agent”, “intelligent service”, etc, “Conversation space,” as the term is used herein, refers to communication that offers a real-time or near real-time transmission of messages between any group of participants or experts and is used interchangeably with “chat room”, “room”, “thread”, “conversation”, “group message”, etc. A conversation space can take any form that is able to take an automatic service like a bot (for example, a group message such as MMS, hangouts, Facebook Messenger, Google style chats, etc.). Once assigned, the virtual assistant is added to the participants in the conversation space.

The conversation space is then analyzed to determine at least one contextual cue associated with the conversation space. In some embodiments, the conversation space is analyzed via natural language processing, which can analyze a title, a topic, and/or a past conversation within the conversation space. The at least one contextual cue is then associated with the virtual assistant. The virtual assistant uses the contextual cues to configure itself, such that when a query from a user is received, the virtual assistant looks for terminology matching its self-configuration parameters. If a user query incorporates or includes terminology that matches or is similar within a threshold value to the configuration, the virtual assistant sends the query to the associated conversation space for resolution.

Additionally and/or alternatively, the conversation space is trained by using one or more machine learning (ML) processes. Training data, for example, can be used as a seed for a ML based decisioning system including, but not limited to, hidden Markov models or simple Bayesian classifiers. As questions are asked of the virtual assistant, the fact that they are answered by a given conversation space or rejected by users of the conversation space can then reinforce the likelihood that the given conversation space can handle a given topic. Accordingly, the virtual assistant can send a query to an associated conversation space for resolution when one or more ML based statistical models determine that, above a given statistical threshold, the query is appropriate for the conversation space.

Once the virtual assistant automatically configures itself to a conversation space it has been assigned to, a system described herein describes how to provide a reply from a conversation space to a query submitted by a user. The system comprises multiple virtual assistants, each virtual assistant assigned to a respective conversation space. Each virtual assistant configures itself to its conversation space by analyzing the respective conversation space to which it is assigned in order to determine one or more contextual cues associated with the respective conversation space. The analysis is based at least in part on natural language processing of a title, a topic, and/or a past conversation within the respective conversation space. A contextual cue database can store associations between the virtual assistant and contextual cues associated with the respective conversation space to which the virtual assistant has been assigned. Additionally and/or alternatively, a ML model that models the likelihood that a conversation space can handle a given topic can generate associations between the virtual assistant and contextual cues associated with the respective conversation space.

The system then answers a user's query through at least two virtual assistants (referred to herein as chatbot and virtual assistant, although chatbot A and chatbot B, respectively, would mean the same thing). A chatbot is configured to interface with the user to receive a topic from the user, and determine which virtual assistant is relevant to the topic. Once determined, the topic is sent to the relevant virtual assistant that is configured to receive the topic from the chatbot and post the topic in the conversation space assigned to it. The virtual assistant receives a reply in the conversation space from a participant and then provides the reply to the chatbot. The chatbot communicates the reply to the user.

### DETAILED DESCRIPTION

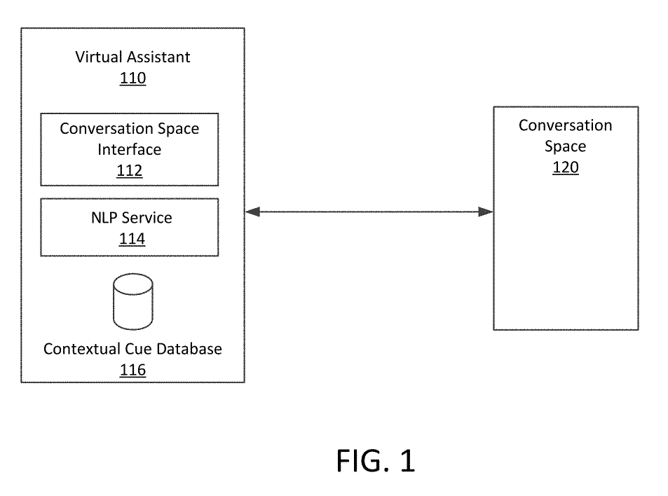

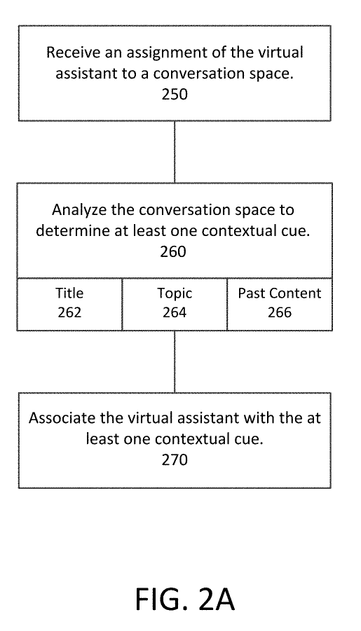

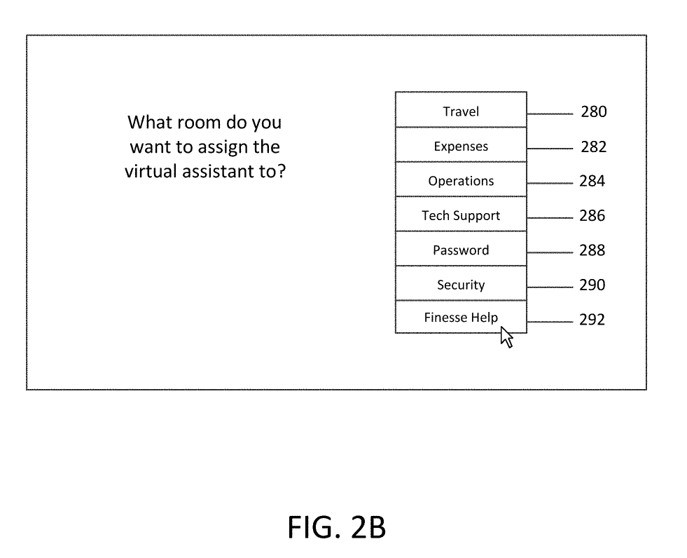

FIG. 1 shows a conceptual block diagram illustrating an example system for virtual assistant configuration capabilities in accordance with various embodiments of the subject technology. FIG. 2A shows a flowchart illustrating an exemplary method for configuring a virtual assistant, and FIG. 2B shows an example embodiment for assigning a virtual assistant to a conversation space.

A system can receive an assignment of virtual assistant 110 to a conversation space (step 250), which, for example, associates virtual assistant 110 to conversation space 120. Conversation space 120 may already be created or otherwise in existence, although no content has to be included within conversation space 120. In the embodiment shown, the assignment of virtual assistant 110 to conversation space 120 opens communication between virtual assistant 110 and conversation space 120 through conversation space interface 112. The assignment furthermore adds virtual assistant 110 to conversation space 120 as a participant.

To further illustrate assigning virtual assistant 110 to conversation space 120, an example user interface is shown in FIG. 2B. The user interface asks the user to assign virtual assistant 110 to conversation space 120 (e.g., by asking the user “what room do you want to assign the virtual assistant to?”). The user is presented multiple existing conversation spaces, with each existing conversation space associated with a functional chat room comprised of expert participants. The functional chat room can be comprised of any topic or range of topics including, but not limited to, banking, account transfer, help/support, travel, scheduling, etc. In the embodiment shown in FIG. 2B, the conversation spaces to choose from are: Travel 280, Expenses 282, Operations 284, Tech Support 286, Password 288, Security 290, and Finesse Help 292, although any number of functional chat rooms can be included. These chat rooms can be selectable, such that a selection of Finesse Help 292 assigns virtual assistant 110 to Finesse Help's chat room (e.g., conversation space 120).

It should be noted that while the embodiment discussed herein contemplates assigning virtual assistant 110 to one conversation space (e.g., conversation space 120), virtual assistant 110 can be assigned with any number of conversation spaces. Thus, virtual assistant 110 can be assigned to multiple conversation spaces as long as each conversation space is associated with a functional chat room that's distinguishable from other conversation spaces.

Referring back to FIGS. 1 and 2A, once virtual assistant 110 has been assigned to conversation space 120, conversation space 120 is analyzed to determine at least one contextual cue (step 260) associated with conversation space 120. While virtual assistant 110 does not know any context about the conversation space it has been assigned to, once virtual assistant 110 has been put into conversation space 120, it will use natural language processing (NLP) or other word spotting methods to parse the content associated with conversation space 120 to learn the context it needs, such as extracting the main topic(s) (e.g., domains) and/or main intents (e.g., categories) of conversation space 120. NLP Service 114 employs natural language processing to identify nouns, verbs, sentence tense, and/or other content identifiers to extract a topic, intent, or both from the content of conversation space 120. For example, the intent of the room can be customer help and the topic of the room can be travel.

Contextual cues are based on the nouns, verbs, sentence tense and syntax, and/or other content identifiers associated with conversation space 120. The combination of syntax and NLP extraction allows virtual assistant 110 to understand what the conversation is about and/or derive meaning from the conversation.

Virtual assistant 110 can determine contextual cues from analyzing a variety of content associated with conversation space 120. For example, virtual assistant 110 may determine contextual cues associated with the title of conversation space 120 (step 262), the topic of conversation space 120 (step 264), and/or a portion or the entirety of conversation space's 120 past content (step 266).

For example, virtual assistant 110 can analyze the past content of conversation space 120 in order to determine main topics and/or intents of conversation space 120. To do this, NLP service 114 uses natural language processing to parse past content of conversation space 120. In some embodiments, virtual assistant 110 parses the entire past content, and thus one or more entire conversations are run (not just, for example, the most recent sentence). In other embodiments, a portion of the past content is run, such as past content that was created within a specified length of time (e.g., content from the past year, 7 months, etc.). In this way. NLP service 114 can identify trends or otherwise keep current with conversation room 120 if the topic and/or intent evolves over time.

On the other hand, if conversation space 120 has just been created and/or otherwise has no past content, NLP service 114 will parse at least the title of conversation space 120. As an example, NLP service 114 may classify “help” as intent and “Finesse” as the topic for a chat room titled “Finesse Help.” Virtual assistant 110 will then refine its configuration over time as more content is added.

Virtual assistant 110 is associated with the contextual cues (step 270) that are determined from the analysis performed by NLP service 114. The NLP service 114 may perform the analysis repeatedly in order to extract the most current contextual cues that reflect conversation space's 120 true topic and/or intent. NLP service 114 may, for example, periodically and/or repeatedly parse conversation space 120 content in order to update or expand the number of contextual cues associated. This increasse the accuracy of virtual assistant's 110 configuration. For example, if the determined topic and/or intent is too broad to be useful (e.g., the user or participants in conversation space 120 indicate that the user's query could not be or was not answered satisfactorily a threshold number of times), NLP service 114 will associate virtual assistant 110 with more contextual cues to narrow the topic and/or intent. If the determined topic and/or intent is too narrow to be useful (e.g., the user's query could not be matched to a conversation space a threshold number of times), NLP service 114 will associate virtual assistant 110 with less contextual cues or with contextual cues that encompass more subject matter in order to generalize or broaden the topic and/or intent. The contextual cues may be stored in contextual cue database 116 so that virtual assistant 110 is informed of what topic(s) and/or intent(s) are discussed in a given conversation space or room.

Conversation space content, however, may change over time as the dialog in conversation space 120 changes. Thus, repeated and/or periodic analysis by NLP service 114 may determine one or more trends in conversation space 120 content, so that virtual assistant 110 updates itself over time. For example, based on periodic parsing (say, parsing past content once a week), NLP service 114 may identify that the topic and/or intent of conversation space 120 has changed. As an example, a chat room titled “Travel Help” may have initially been set up to help customers make travel arrangements (e.g., booking flights, reserving hotels and rental cars, etc.). However, over time, the participants in the chat room may find themselves addressing complaints from users about flights or the quality of travel arrangements, such that the chat room has become a place for feedback and quality review. Thus, NLP service 114 may determine that the “Travel Help” room may have changed from a travel arrangement help room to a quality review room. Thus, even though the title of the chat room has not been manually changed to reflect the change in conversation space intent or topic, virtual assistant 110 will detect the change itself and then configure itself accordingly by updating the contextual cues stored in contextual cue database 116.

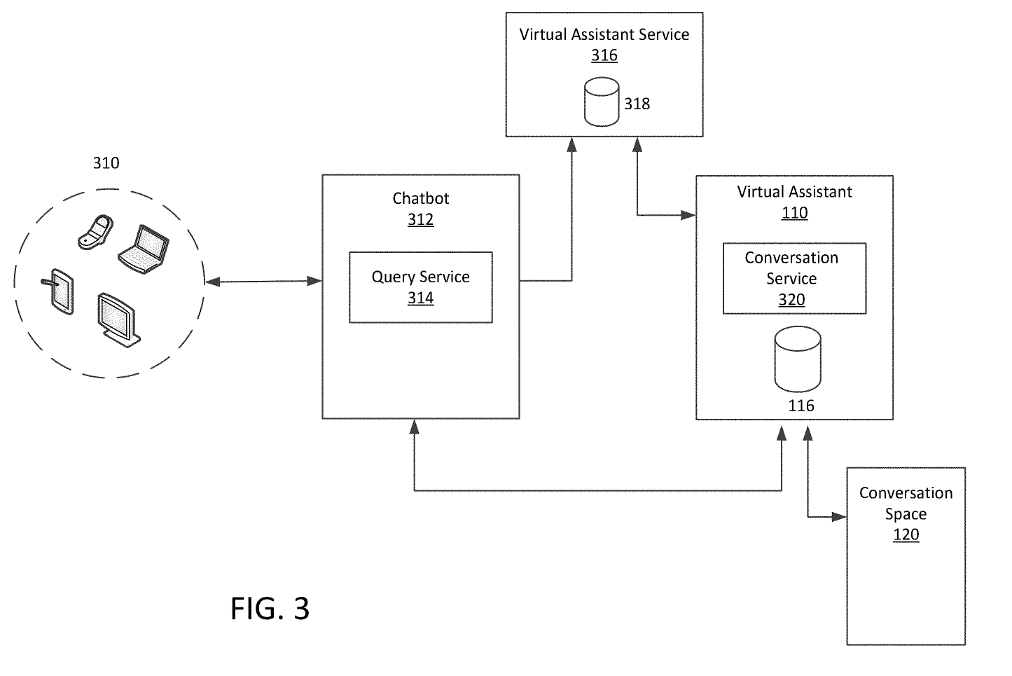

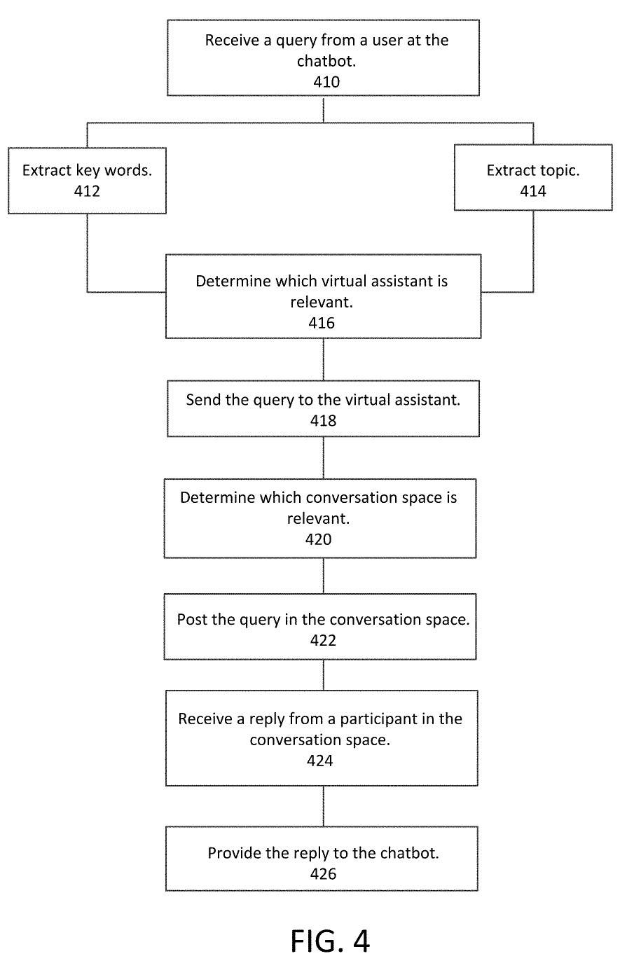

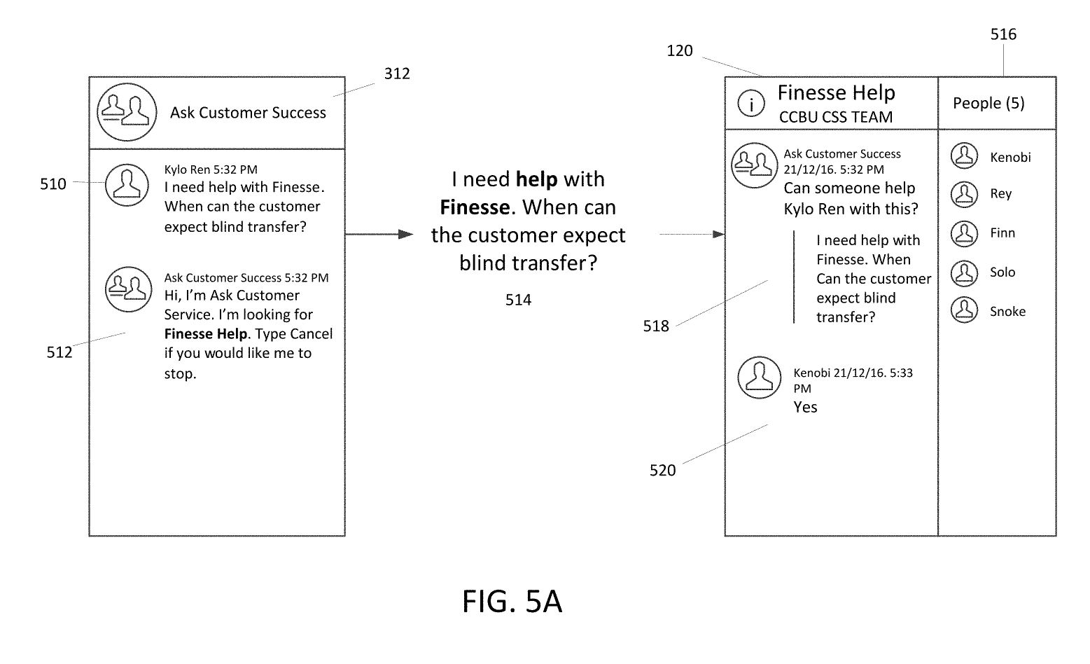

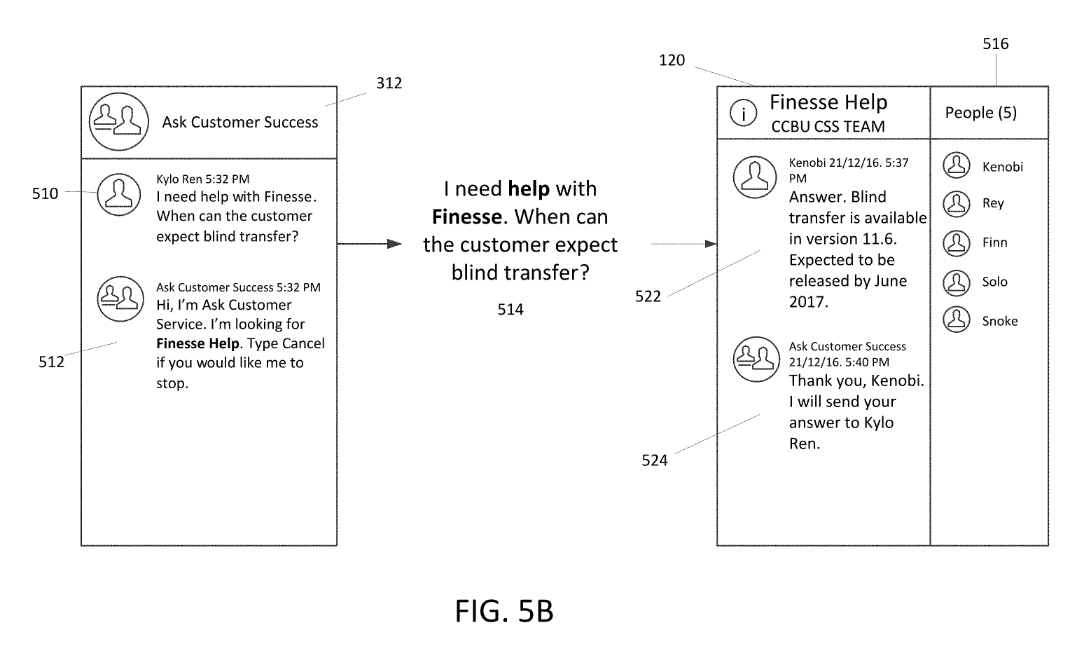

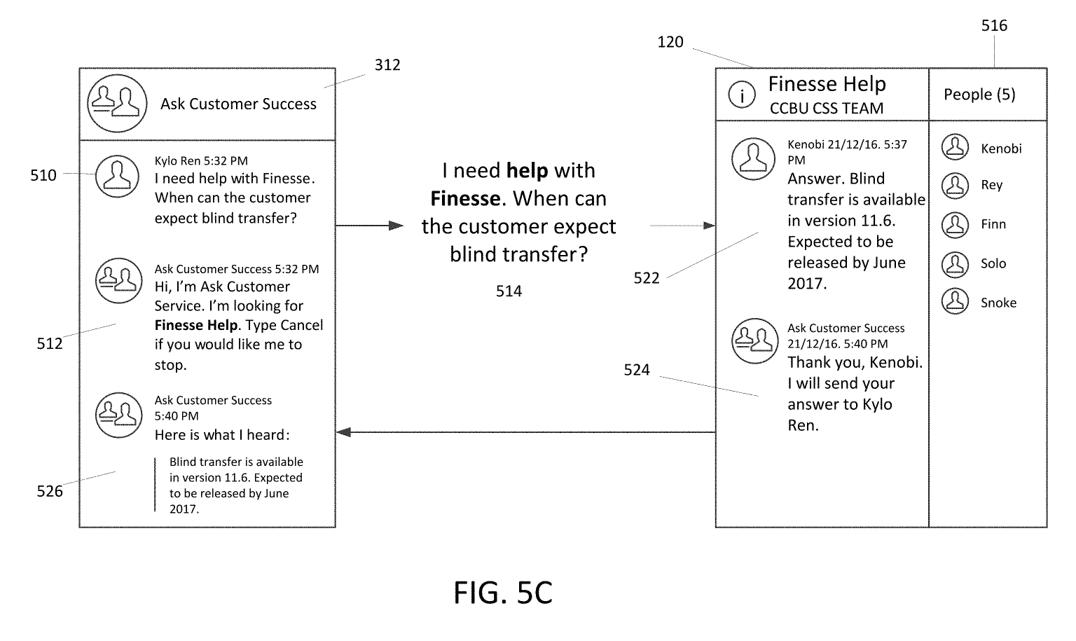

The system can furthermore provide virtual assistant services to a user, as is shown in FIGS. 3-5C. FIG. 3 shows a conceptual block diagram illustrating an example system for providing virtual assistant services, in accordance with various embodiments of the subject technology. FIG. 4 shows a flowchart illustrating an exemplary method for providing virtual assistant services, while FIGS. 5a-5C show related user interfaces.

Referring to FIG. 3, chatbot 312 is configured to interface with a user to receive a query, which can be a request for assistance with a topic. Chatbot 312 interfaces may be achieved by communicating with user device 310 to receive the query from the user (step 410). User device 310 may be, for example, a user's smart phone, tablet, laptop, or any other computing device. Query service 314 uses NLP or other word spotting methods to parse the query from user device 310 to extract the main topic or topics (step 414) and/or key words (step 412). Query service 314 extracts the topic and/or key words by identifying nouns, verbs, sentence tense, and/or other content identifiers using NLP processes or other similar word search techniques. In some embodiments, multiple extracted key words can be used to determine the topic of the query.

FIG. 5A shows an example user interface for submitting a query. In the embodiment shown, user Kylo Ren interfaces with chatbot 312 named Ask Customer Success to initiate a one-on-one conversation and make a query. In the conversation, Kylo Ren makes query 510 “I need help with Finesse. When can the customer expect blind transfer?” Query service 314 uses NLP to extract the topic and/or keywords as “Finesse” and “help.” Chatbot 312 may, in some embodiments, confirm receipt of query and inform 512 the user what it has extracted (e.g., Hi, I'm Ask Customer Success. I'm looking for Finesse Help”). Moreover, chatbot 312 may offer the user the chance to cancel the communication or let system know that the topic and/or keywords extracted are incorrect (e.g., “Type Cancel if you would like me to stop.”).

Chatbot 312 sends 514 query 510 and the extracted topics and/or key words to virtual assistant service 316. Virtual assistant service 316 may be in communication with many virtual assistants. Based on the extracted topics and/or key words, virtual assistant service 316 determines which virtual assistant is relevant to the query (step 416). Relevance may be determined based on a directory or virtual assistant database 318 that stores information about all the virtual assistants within the system. Virtual assistant database 318 may furthermore include contextual cues associated with each virtual assistant, such that the extracted topics and/or key words of the query can be matched with the contextual cues. Virtual assistants associated with one or more matching or similar contextual cues are considered to be relevant to the query. The extracted topics and/or key words may be an exact match or may be determined to be similar within a threshold range.

Once a virtual assistant has been determined as relevant (e.g., say, virtual assistant 110 is determined to be similar or relevant to the query “I need help with Finesse. When can the customer expect blind transfer?”), virtual assistant service 316 sends the query 510 and extracted key words and/or topics to that relevant virtual assistant (e.g., virtual assistant 110) (step 418).

In the embodiments in which virtual assistant 110 has been assigned to multiple conversation spaces, virtual assistant will determine which conversation space is relevant (step 420), such as by matching extracted key words or topics from the query to contextual cues associated with each conversation space.

Conversation service 320 is then configured to receive the extracted key words and/or topic and post the query in conversation space 120 assigned to virtual assistant 110 (step 422). FIG. 5A shows an example embodiment of Conversation service 320 posting query 510 in conversation space 120. Conversation space 120 is a chat room titled “Finesse Help: CCBU CSS Team,” which includes virtual assistant (Ask Customer Success) and five participants 516: Kenobi, Rey, Finn, Solo, and Snoke. Participants 516 may be experts with specialized knowledge of the topics covered by conversation space 120. In the shown example, virtual assistant directs the query to conversation space 120 and posts the query 518 (e.g., “I need help with Finesse. When can the customer expect blind transfer?”). In some embodiments, the post 518 may wrap the query with a request that participants 516 confirm whether the query can be addressed (e.g., “Can someone help Kylo Ren with this?” or “Can someone help Kylo Ren with this?: I need help with Finesse. When can the customer expect blind transfer?”).

One or more participants 516 can confirm 520 that they are able to address or assist with query 510. For example, participant Kenobi may respond “yes,” “y,” or other similar way to indicate that he has an answer to query 510. In some embodiments, a participant 516 can indicate that he or she cannot answer query 510 or that query 510 is not relevant to conversation space 120 by responding “no,” “n,” or other similar way.

Referring to FIG. 5B, participant 516 provides a reply 522 to query 510. For example, Kenobi may answer Kylo Ren's question with “Answer. Blind transfer is available in version 11.6. Expected to be released by June 2017.” Virtual assistant 120 is configured to receive participant's 516 reply 522 (step 424). In some embodiments, virtual assistant 120 can confirm 524 receipt of the reply, such as by stating “Thank you, Kenobi. I will send your answer to Kylo Ren.”

Once virtual assistant 120 receives reply 522, virtual assistant 120 is configured to provide reply 522 to chatbot 312 to be communicated to the user (step 426). For example, FIG. 5C shows that Kenobi's reply is posted to user at 526 (e.g., “Here is what I heard: Blind transfer is available . . . ”). Thus, the user receives an answer to their question without interacting with a participant in conversation space 120.

While not illustrated, in some embodiments, virtual assistant service 316 and/or virtual assistant 110 will evolve over time to become more autonomous in understanding the query and providing a reply. Conversation service 320 may parse, periodically, a portion of past content of conversation space 120 using NLP, including replies to user queries. Virtual assistant service 316 and/or virtual assistant 110 may determine that the same or similar query has been made a threshold number of times, which has received a same or similar answer from the participants 516. In this instance, conversation service 320 uses NLP to categorize questions and answers to determine that they are similar within a threshold confidence. Once the query has been asked a threshold number of times, virtual assistant service 316 and/or virtual assistant 110 will flag the query as appropriate for being the subject of a help article (e.g., 50 queries of “how do I reset my password?” is an indication that a help article that answers that question is appropriate). Additionally and/or alternatively, virtual assistant service 316 and/or virtual assistant 110 will automatically provide a reply to chatbot 312 without posting the topic in the respective existing conversation space.

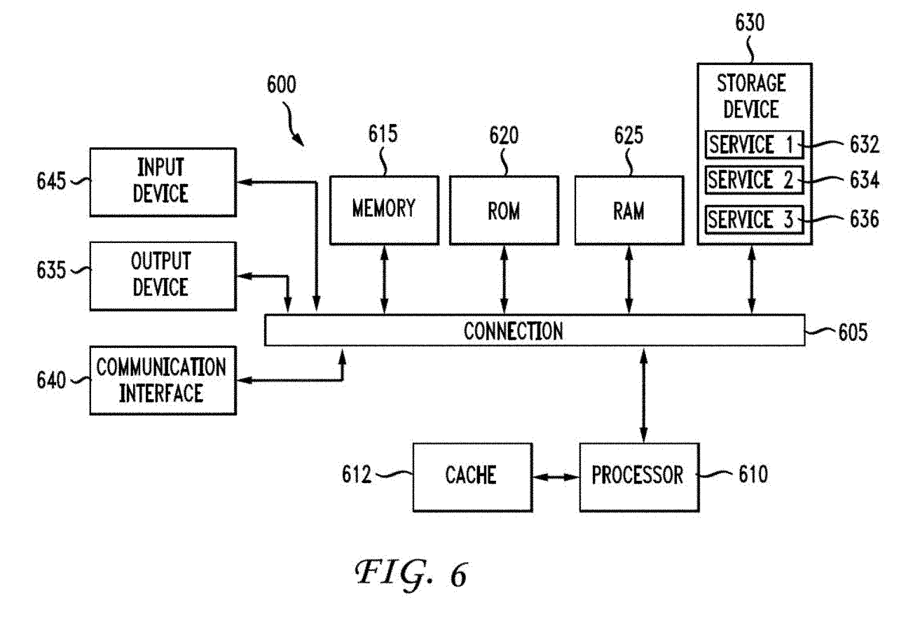

FIG. 6 shows an example of computing system 600 in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple datacenters, a peer network, etc. In some embodiments, one or more of the described system components represents many such components, each performing some or all of the function for which the component is described. In some embodiments, the components can be physical or virtual devices.

Example system 600 includes at least one processing unit (CPU or processor) 610 and connection 605 that couples various system components, including system memory 615, such as read only memory (ROM) and random access memory (RAM), to processor 610. Computing system 600 can include a cache of high-speed memory connected directly with, in close proximity to, or integrated as part of processor 610.

Processor 610 can include any general purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. There is no restriction on operating on any particular hardware arrangement and therefore the basic features here may easily be substituted for improved hardware or firmware arrangements as they are developed.

Storage device 630 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as processor 610, connection 605, output device 635, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a portable device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A method of automatically configuring a virtual assistant comprising:
receiving an assignment of the first virtual assistant to an existing conversation space, wherein the assignment includes the first virtual assistant as a participant in the existing conversation space;
analyzing the existing conversation space to determine at least one contextual cue of the existing conversation space, wherein the analyzing includes natural language processing of a title, a topic, or a past conversation of the existing conversation space; and
associating the first virtual assistant with the at least one contextual cue.

2. The method of claim 1, comprising:
receiving a request for assistance with a topic;
determining that the topic relates to the at least one contextual cue associated with the first virtual assistant; and
sending the topic to the first virtual assistant for submission to the conversation space by the first virtual assistant.

3. The method of claim 1, wherein the first virtual assistant is assigned to multiple existing conversation spaces, each existing conversation space associated with a functional chat room comprised of expert participants.

4. The method of claim 1, wherein the first virtual assistant analyzes the existing conversation space by using natural language understanding to parse at least a portion of past content of the existing conversation space.

5. The method of claim 4, wherein the first virtual assistant parses the past content to determine the topic and intent associated with the existing conversation space.

6. The method of claim 1, further comprising:
parsing, periodically, a portion of past content of the existing conversation space;
based on the periodic parsing, determining a trend in at least one of the topic or intent of the existing conversation space; and
updating the at least one contextual cue associated with the first virtual assistant.

7. The method of claim 1, wherein analyzing the existing conversation space comprises a machine learning based decisional system that generates one or more statistical models of the existing conversation space.

8. A system comprising:
a plurality of virtual assistants, each of the plurality of virtual assistants being assigned to a respective existing conversation space, wherein each of the plurality of virtual assistants analyzing the respective existing conversation space to which it is assigned to determine at least one contextual cue of the respective existing conversation space, wherein the analyzing includes natural language processing of a title, a topic, or a past conversation of the respective existing conversation space;
a contextual cue database storing an association between the plurality of virtual assistants and the at least one contextual queue of the respective existing conversation space to which it is assigned; and
a chatbot configured to interface with a user to receive a query, and determine one of the plurality of virtual assistants associated with the at least one contextual cue that is relevant to the query, and to send the query to the determined one of the plurality of virtual assistants,
wherein the one of the plurality of virtual assistants is configured to receive the query from the chatbot and to post the query in the respective existing conversation space to which the one of the plurality of virtual assistants is assigned,
wherein the one of the plurality of virtual assistants is configured to receive a reply in the respective existing conversation space to which the one of the plurality of virtual assistants is assigned, and to provide the reply to the chatbot to be communicated to the user.

9. The system of claim 8, wherein the one of the plurality of virtual assistants is assigned to multiple existing conversation spaces, each existing conversation space associated with a functional chat room comprised of expert participants.

10. The system of claim 8, wherein the one of the plurality of virtual assistants analyzes the existing conversation space by using natural language understanding to parse at least a portion of past content of the existing conversation space.

11. The system of claim 10, wherein the one of the plurality of virtual assistants parses the past content to determine the topic and intent associated with the existing conversation space.

12. The system of claim 8, wherein the one of the plurality of virtual assistants is configured to:
parse, periodically, a portion of past content of the existing conversation space;
based on the periodic parsing, determine a trend in at least one of the topic or intent of the existing conversation space; and
update the at least one contextual cue associated with the first virtual assistant.

13. The system of claim 12, the one of the plurality of virtual assistants further configured to:
determine that the trend is based on a topic that is repeated over a threshold number of times; and
based on the trend determined, flag the topic as a help article topic.

14. The system of claim 12, the one of the plurality of virtual assistants further configured to:
determine that the trend is based on a topic that is repeated over a threshold number of times; and
based on the trend determined, provide the reply to the chatbot without posting the topic in the respective existing conversation space.

15. A computer program product residing on a non-transitory computer readable storage medium having a plurality of instructions stored thereon, which when executed by a processor, cause the processor to perform operations comprising:
receiving an assignment of the first virtual assistant to an existing conversation space, wherein the assignment includes the first virtual assistant as a participant in the existing conversation space;
analyzing the existing conversation space to determine at least one contextual cue of the existing conversation space, wherein the analyzing includes natural language processing of a title, a topic, or a past conversation of the existing conversation space; and
associating the first virtual assistant with the at least one contextual cue.

16. The computer program product of claim 15, further comprising:
receiving a request for assistance with a topic;
determining that the topic relates to the at least one contextual cue associated with the first virtual assistant; and
sending the topic to the first virtual assistant for submission to the conversation space by the first virtual assistant.

17. The computer program product of claim 16, wherein the first virtual assistant is assigned to multiple existing conversation spaces, each existing conversation space associated with a functional chat room comprised of expert participants.

18. The computer program product of claim 16, wherein the first virtual assistant analyzes the existing conversation space by using natural language understanding to parse at least a portion of past content of the existing conversation space.

19. The computer program product of claim 18, wherein the first virtual assistant parses the past content to determine the topic and intent associated with the existing conversation space.

20. The computer program product of claim 16, further comprising:
parsing, periodically, a portion of past content of the existing conversation space;
based on the periodic parsing, determining a trend in at least one of the topic or intent of the existing conversation space; and
updating the at least one contextual cue associated with the first virtual assistant.

21. The computer program product of claim 20, further comprising:
determining that the trend is based on a topic that is repeated over a threshold number of times; and
based on the trend determined, flagging the topic as a help article topic.
